(19) United States
(12) Patent Application Publication
(10) Pub. No.: US 2022/0271280 A1
(43) Pub. Date: Aug. 25, 2022

(54) A LITHIUM NEGATIVE ELECTRODE WITH PROTECTIVE LAYER, PREPARATION METHOD AND APPLICATION THEREOF

(71) Applicant: South China University of Technology, Guangzhou City (CN)

(72) Inventors: Wei Yuan, Guangzhou City (CN); Chun Wang, Guangzhou City (CN); Qiqi Pan, Guangzhou City (CN); Cheng Wang, Guangzhou City (CN); Yuhang Yuan, Guangzhou City (CN); Zhiqiang Qiu, Guangzhou City (CN); Yong Tang, Guangzhou City (CN)

(21) Appl. No.: 17/438,035

(22) PCT Filed: Oct. 30, 2020
(86) PCT No.: PCT/CN2020/125375

§ 371 Date: Sep. 10, 2021

(30) Foreign Application Priority Data
Nov. 6, 2019 (CN) 201911076090.1

(51) Int. Cl. H01M 4/38; H01M 4/04; H01M 10/052; H01M 4/62

(52) U.S. Cl. CPC H01M 4/382; H01M 4/0416; H01M 10/052; H01M 4/628; H01M 2004/027

(57) ABSTRACT

Disclosed are a lithium negative electrode with a protective layer (1), a preparation method and an application thereof. The protective layer (1) of the lithium negative electrode is located on a surface of the electrode, and the protective layer (1) is a lithiated perfluorosulfonic acid membrane doped with nano molybdenum disulfide (3). The preparation method for the lithium negative electrode with the protective layer (1) comprises the following steps of: I. lithiation of a perfluorosulfonic acid; II. loading of the molybdenum disulfide (3); and III. coating and curing of the protective layer (1). The protective layer (1) of the lithium metal negative electrode of a lithium battery is capable of effectively inhibiting lithium dendrites, and weakening a shuttle effect, thereby improving a charge and discharge capacity, a rate capability and a cycle life of a lithium-sulfur battery.

### TECHNICAL FIELD

The present disclosure relates to the field of lithium battery technologies, and more particular, to a lithium negative electrode with a protective layer, a preparation method and an application thereof.

### BACKGROUND

In a lithium-sulfur battery, a theoretical specific capacity of a lithium metal negative electrode pair is about 3860 mAh·g⁻¹, but the lithium metal is very active in property, and is easy to dissolve and deposit in an electrolyte during a battery cycle. Meanwhile, with the dissolution of the lithium metal, a roughness of a negative electrode can be increased. Moreover, a polysulfide formed by lithium and sulfur may migrate back to a positive electrode. These factors lead to a serious shuttle effect and lithium dendrite formation in a conventional lithium-sulfur battery, so that a capacity of the lithium-sulfur battery is decreased and faded rapidly.

Therefore, in order to inhibit the lithium dendrite formation, reduce the capacity fading caused by the shuttle effect and improve a comprehensive performance of the lithium-sulfur battery, the research on an ion-selective lithium negative electrode protective layer and a key manufacturing technology thereof has attracted extensive interest of researchers at home and abroad.

### SUMMARY

To overcome the shortcomings of an existing lithium metal negative electrode of a lithium battery, the first objective of the present disclosure is to provide a lithium negative electrode with a protective layer, the second objective of the present disclosure is to provide a preparation method for the lithium negative electrode with the protective layer, and the third objective of the present disclosure is to provide an application of the lithium negative electrode with the protective layer in a lithium-sulfur battery.

To achieve the above objectives, the technical solutions used in the present disclosure are as follows.

The present disclosure provides a lithium negative electrode with a protective layer, wherein the protective layer of the lithium negative electrode is located on a surface of the electrode, and the protective layer is a lithiated perfluorosulfonic acid membrane doped with nano molybdenum disulfide.

Preferably, in the protective layer, a mass ratio of the nano molybdenum disulfide to the lithiated perfluorosulfonic acid is 1: (0.5˜2); and further preferably, the mass ratio of the nano molybdenum disulfide to the lithiated perfluorosulfonic acid is 1: (0.8˜1.2).

Preferably, in the protective layer, the nano molybdenum disulfide is a sheet-shaped nano molybdenum disulfide.

Preferably, the protective layer has a thickness of 150 μm to 350 μm; and further preferably, the protective layer has a thickness of 200 μm to 300 μm.

The present disclosure further provides a preparation method for the above lithium negative electrode with the protective layer.

A preparation method for the lithium negative electrode with the protective layer includes the following steps of:

I. Lithiation of the Perfluorosulfonic Acid
1) mixing a lithium source compound with a perfluorosulfonic acid resin solution to obtain a lithiated perfluorosulfonic acid dispersion;
2) drying the lithiated perfluorosulfonic acid dispersion to obtain a solid Li-Nafion polymer; and
3) mixing the solid Li-Nafion polymer with a solvent under stirring to obtain a Li-Nafion dispersion liquid;

II. Loading of the Molybdenum Disulfide
mixing the nano molybdenum disulfide with the Li-Nafion dispersion liquid under stirring to obtain a loading liquid; and

III. Coating and Curing of the Protective Layer
coating the loading liquid on a surface of a lithium sheet, and drying to obtain the lithium negative electrode with the protective layer.

Preferably, in the step 1) of the lithiation of the perfluorosulfonic acid according to the preparation method, a dosage ratio of Li in the lithium source compound to the perfluorosulfonic acid resin solution is 1 g: (1˜5) L; further preferably, the dosage ratio of Li in the lithium source compound to the perfluorosulfonic acid resin solution is 1 g: (2˜4) L; and further preferably, the dosage ratio of Li in the lithium source compound to the perfluorosulfonic acid resin solution is 1 g: (2.2˜2.6) L.

Preferably, in the step 1) of the lithiation of the perfluorosulfonic acid according to the preparation method, the lithium source compound is selected from at least one of lithium acetate, lithium carbonate, lithium fluoride, lithium hydroxide, lithium oxalate, and lithium chloride; further preferably, the lithium source compound is selected from at least one of lithium acetate, lithium carbonate, lithium hydroxide, and lithium oxalate; and most preferably, the lithium source compound is selected from lithium hydroxide. In some preferred specific embodiments of the present disclosure, the lithium source compound is selected from a lithium hydroxide hydrate, i.e., LiOH.H₂O.

Preferably, in the step 1) of the lithiation of the perfluorosulfonic acid according to the preparation method, a mass percentage of the perfluorosulfonic acid resin in the perfluorosulfonic acid resin solution is 1% to 10%. In some preferred specific embodiments of the present disclosure, the perfluorosulfonic acid resin solution is selected from 5 wt % Nafion solution. A solvent of the Nafion solution includes alcohol and water, and may be selected from a commercial product, such as propanol and aqueous solutions of Nafion.

Preferably, in the step 1) of the lithiation of the perfluorosulfonic acid according to the preparation method, the mixing is performed at a stirring speed of 200 rpm to 800 rpm for 1 hour to 4 hours, and a mixing and stirring temperature is 40° C. to 70° C.; and further preferably, the mixing is performed at a stirring speed of 400 rpm to 600 rpm for 2.5 hours to 3.5 hours, and the mixing and stirring temperature is 45° C. to 55° C.

Preferably, in the step 2) of the lithiation of the perfluorosulfonic acid according to the preparation method, the drying is performed at 50° C. to 90° C. for 8 hours to 15 hours; further preferably, the drying is performed at 55° C. to 65° C. for 11 hours to 13 hours; and the drying is performed in vacuum.

Preferably, in the step 3) of the lithiation of the perfluorosulfonic acid according to the preparation method, a mass ratio of the solid Li-Nafion polymer to the solvent is 1: (50˜200); and further preferably, the mass ratio of the solid Li-Nafion polymer to the solvent is 1: (80˜120).

Preferably, in the step 3) of the lithiation of the perfluorosulfonic acid according to the preparation method, the solvent is selected from at least one of N-methyl pyrrolidone (NMP), acetone, tetrahydrofuran, N,N-dimethylformamide (DMF), and dimethyl sulfoxide; and most preferably, the solvent is N-methyl pyrrolidone.

Preferably, in the step 3) of the lithiation of the perfluorosulfonic acid according to the preparation method, the mixing and the stirring are performed at a stirring speed of 200 rpm to 800 rpm for 3 hours to 8 hours; and further preferably, the mixing and the stirring are performed at a stirring speed of 400 rpm to 600 rpm for 5 hours to 7 hours.

Preferably, in the step of the loading of the molybdenum disulfide according to the preparation method, a mass ratio of the nano molybdenum disulfide to the Li-Nafion dispersion liquid is 1: (20˜200); and further preferably, the mass ratio of the nano molybdenum disulfide to the Li-Nafion dispersion liquid is 1: (80˜120).

Preferably, in the step of the loading of the molybdenum disulfide according to the preparation method, the mixing and the stirring are performed at a stirring speed of 200 rpm to 800 rpm for 8 hours to 15 hours; and further preferably, the mixing and the stirring are performed at a stirring speed of 400 rpm to 600 rpm for 11 hours to 13 hours.

Preferably, in the step of the coating and curing of the protective layer according to the preparation method, the coating specifically includes dropwise adding the loading liquid to a surface of a lithium sheet, and then coating evenly.

Preferably, in the step of the coating and curing of the protective layer according to the preparation method, a dosage of the loading liquid is 10 μL to 100 μL; and further preferably, a dosage of the loading liquid is 40 μL to 60 μL.

Preferably, in the step of the coating and curing of the protective layer according to the preparation method, a diameter of the lithium sheet is 5 mm to 30 mm; and further preferably, the diameter of the lithium sheet is 10 mm to 20 mm.

Preferably, in the step of the coating and curing of the protective layer according to the preparation method, the drying includes a pre-drying and a secondary drying. The pre-drying is performed until no liquid exists on the surface of the lithium sheet, and then the secondary drying is performed to complete the curing of the protective layer.

Preferably, in the step of the coating and curing of the protective layer according to the preparation method, the pre-drying is performed at 20° C. to 30° C. for 8 hours to 20 hours; and further preferably, the pre-drying is performed at 23° C. to 28° C. for 14 hours to 16 hours.

Preferably, in the step of the coating and curing of the protective layer according to the preparation method, the secondary drying is performed at 50° C. to 80° C. for 3 hours to 6 hours; and further preferably, the secondary drying is performed at 55° C. to 65° C. for 3.5 hours to 4.5 hours.

Preferably, in the step of the coating and curing of the protective layer according to the preparation method, the pre-drying and the secondary drying are both performed in an inert atmosphere, such as drying in an argon atmosphere.

The present disclosure further provides an application of the above lithium negative electrode with the protective layer, and specifically an application of the above lithium negative electrode with the protective layer in a lithium-sulfur battery.

The present disclosure further provides a lithium-sulfur battery.

A lithium-sulfur battery, wherein a negative electrode of the lithium-sulfur battery is the above lithium negative electrode.

Further, when the above lithium negative electrode with the protective layer is used to prepare a battery, the above lithium negative electrode with the protective layer is used as a negative electrode of the battery, which is directly in close contact with a gasket.

The present disclosure has the beneficial effects as follows:

The protective layer of the lithium metal negative electrode of the lithium battery according to the present disclosure is capable of effectively inhibiting lithium dendrite formation, and weakening a shuttle effect, thereby improving a charge and discharge capacity, a rate capability and a cycle life of the lithium-sulfur battery.

Specifically, compared with the prior art, the present disclosure has the following advantages:

1. The protective layer of the lithium negative electrode of the present disclosure contains the perfluorosulfonic acid resin, and the Nafion plays a positive role in inhibiting lithium dendrite formation and preventing the shuttle effect.

2. In the protective layer of the lithium negative electrode of the present disclosure, MoS₂ doped in a Nafion membrane can increase a density of a negative charge center, thereby improving an ion conductivity.

3. In the protective layer of the lithium negative electrode of the present disclosure, an interaction between the MoS₂ and the Nafion limits a mobility of a Nafion main chain, so that a mechanical property can be effectively improved.

### BRIEF DESCRIPTION OF THE DRAWINGS

FIG. 1 is a schematic diagram of a structure of a protective layer of a lithium negative electrode;

FIG. 2 is a schematic diagram of a micro-structure of the protective layer of the lithium negative electrode;

FIG. 3 is a schematic diagram of assembly of a lithium ion half-cell;

FIG. 4 is a diagram of a cycle performance of a lithium ion half-cell with the protective layer of the lithium negative electrode under 0.5 C;

FIG. 5 is a diagram of a cycle performance of a lithium ion half-cell based on a common lithium sheet under 0.5 C; and

FIG. 6 is a diagram of rate performance comparison between the lithium ion half-cell with the protective layer of the lithium negative electrode and the lithium ion half-cell based on the common lithium sheet.

Reference numerals: 1 refers to protective layer, 2 refers to lithium sheet, 3 refers to nano MoS₂, 4 refers to Nafion, 5 refers to upper battery case, 6 refers to gasket, 7 refers to elastic piece, 8 refers to lithium sheet, 9 refers to lower battery case, 10 refers to electrolyte, 11 refers to electrode sheet, and 12 refers to diaphragm.

### DETAILED DESCRIPTION

The contents of the present disclosure are further described in detail hereinafter with reference to the specific examples. Unless otherwise specified, the raw materials, reagents or devices used in the examples and the comparative examples may all be obtained from conventional commercial sources. Unless otherwise specified, the experiment or test methods are all conventional methods in the art.

Example of preparation of lithium negative electrode with protective layer

A preparation method for the lithium negative electrode with the protective layer included the following steps.

I. Lithiation of Perfluorosulfonic Acid

1) 0.025 g of lithium hydroxide monohydrate was added into 10 mL of perfluorosulfonic acid resin solution (5% perfluorosulfonic acid resin, (48±3)% 1-propanol, <4% ethanol, and (45±3)% water by mass, which are commercially available pure liquid raw materials), and stirred at 50° C. at 500 rpm for 3 hour to disperse the lithium hydroxide monohydrate in the perfluorosulfonic acid solution, so as to obtain a lithiated perfluorosulfonic acid dispersion.

2) The lithiated perfluorosulfonic acid dispersion was dried in a vacuum drying oven at 60° C. for 12 hours to obtain a solid Li-Nafion polymer.

3) 0.1 g of solid Li-Nafion polymer was added into 9.9 g of NMP, and stirred at 500 rpm for 6 hours to disperse the Li-Nafion polymer in the NMP, so as to obtain a Li-Nafion dispersion liquid.

II. Loading of Functional Material MoS₂

0.1 g of sheet-shaped nano MoS₂ was added into 10 g of Li-Nafion dispersion liquid, and stirred at 500 rpm for 12 hours to complete the loading of the functional material, so as to obtain a loading liquid.

III. Coating and Curing of Protective Layer

50 μL of loading liquid was dropwise added on a surface of a lithium sheet, and uniformly coated with a glass rod on the surface of the lithium sheet with a diameter of 15 mm. The obtained lithium sheet was pre-dried in an argon atmosphere at 25° C. for 15 hours until no liquid existed on the surface, and then was subjected to secondary drying at 60° C. for 4 hours in the argon atmosphere to complete the curing of the protective layer, so as to obtain the lithium sheet with the protective layer.

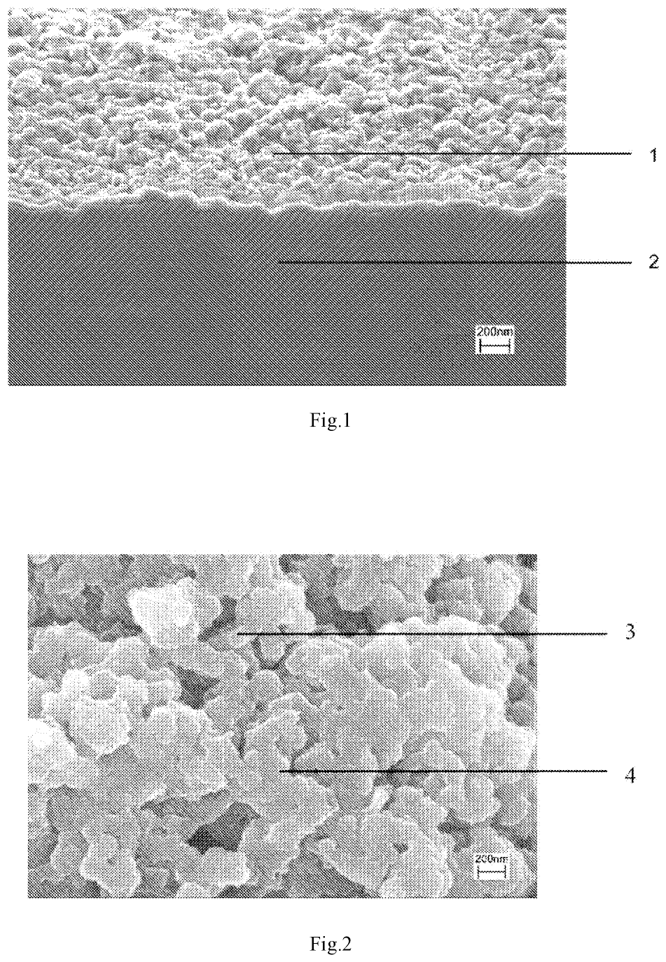

A thickness of the protective layer of the lithium negative electrode prepared in the example is 280 μm, and a schematic diagram of a structure of the protective layer of the lithium negative electrode is shown in FIG. 1. A morphology of the lithium negative electrode with the protective layer is characterized and analyzed, and FIG. 2 is a schematic diagram of a micro-structure of the protective layer of the lithium negative electrode. It can be seen from FIG. 2 that the nano MoS₂ is successfully loaded on a Nafion membrane.

Preparation of Lithium Battery

The lithium sheet with the protective layer prepared above is used for preparing a lithium-sulfur battery. When assembling a battery, the lithium sheet with the protective layer is used as a negative electrode of the battery, and a top surface of the protective layer is in direct contact with a diaphragm, while a back surface of the lithium sheet is in direct close contact with a battery case.

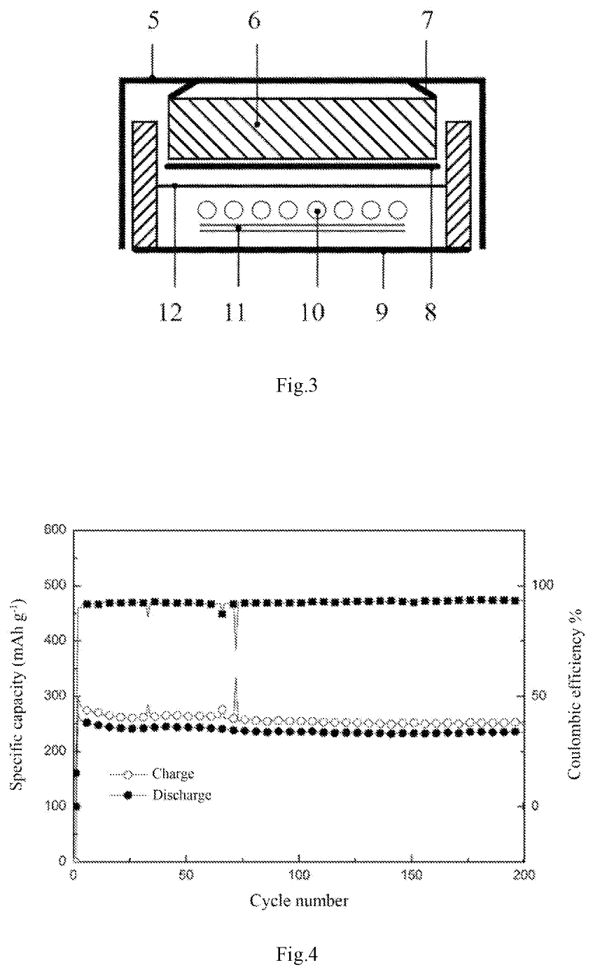

FIG. 3 is a schematic diagram of assembly of a lithium ion half-cell. As shown in FIG. 3, the lithium ion half-cell with the protective layer of the lithium metal negative electrode used for the lithium-sulfur battery is assembled, an electrode sheet 11 is placed on a lower battery case 9, an electrolyte 10 directly infiltrates an active substance on the electrode sheet 11, and the electrolyte 10 fills a whole cavity composed of the electrode sheet 11, the lower battery case 9 and a diaphragm 12. A lithium sheet 8 is closely attached to the diaphragm 12, a gasket 6 and an elastic piece 7 are sequentially placed on an upper surface of the lithium sheet 8 from bottom to top, and the gasket 6 and the elastic piece 7 are used for adjusting a pressure of the battery. The elastic piece 7 is in close contact with the upper battery case 5 to reduce a contact resistance and ensure a good electrical conductivity inside the battery.

When the lithium ion half-cell is discharged, the lithium sheet 8 occurs delithiation, and lithium ions enter the electrolyte 10 through the diaphragm 12, and then contact with the active substance on the electrode sheet 11, resulting in a lithium intercalation reaction. Meanwhile, electrons enter the lower battery case 9 through the gasket 6, the elastic piece 7 and the upper battery case 5 in sequence. Since the lower battery case 9 is in close contact with the electrode sheet 11, the electrons then enter the active substance on the electrode sheet 11 to perform charge neutralization with the lithium ions, thereby completing a discharge process of the lithium ion half-cell. When the lithium ion half-cell is charged, the lithium ions are separated from the active substance on the electrode sheet 11 first, enter the electrolyte 10, and then contact with the lithium sheet 8 through the diaphragm 12. The electrons are transferred from the active substance on the electrode sheet 11, and pass through the lower battery case 9, the upper battery case 5, the elastic piece 7 and the gasket 6 in sequence to perform charge balance with the lithium ions on the lithium sheet 8, thereby completing a charging process.

A cycle performance and a rate performance of the lithium ion half-cell with the protective layer of the lithium metal negative electrode prepared in the example are tested by a LAND CT2001A battery test system. Meanwhile, a common lithium sheet (without the protective layer) is selected for a comparative test.

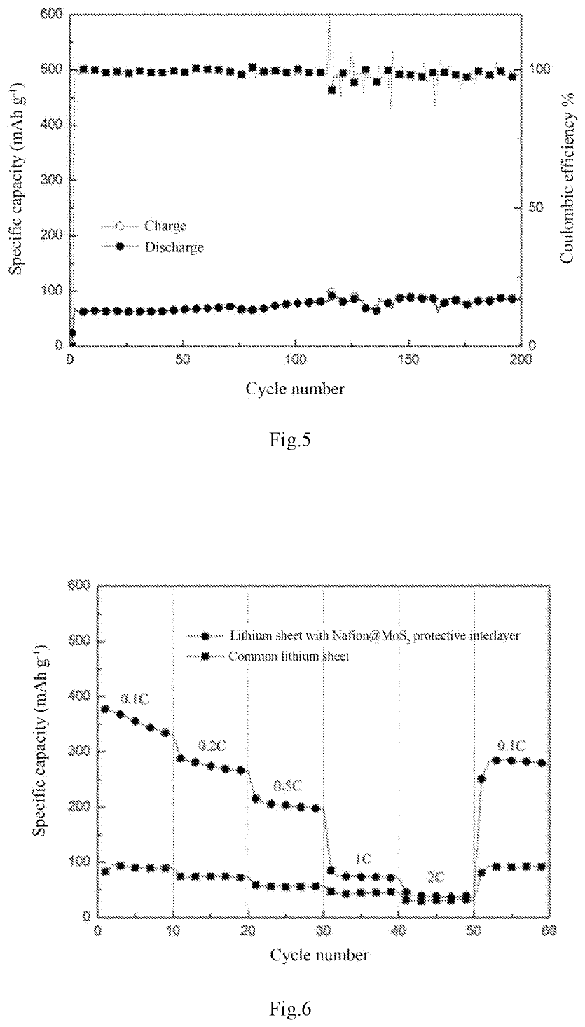

FIG. 4 is a diagram of the cycle performance of the lithium ion half-cell with the protective layer of the lithium negative electrode under 0.5 C. FIG. 5 is a diagram of the cycle performance of the lithium ion half-cell based on the common lithium sheet under 0.5 C. Black box curves in FIG. 4 and FIG. 5 represent a coulombic efficiency corresponding to a right coordinate axis. It can be seen from FIG. 4 that after the lithium ion half-cell with the protective layer of the lithium negative electrode is cycled for 200 times at a rate of 0.5 C, a reversible capacity can still reach 234.6 mAh·g⁻¹, and a capacity retention rate is over 92.1% However, it can be seen from FIG. 5 that under same conditions, a reversible capacity of the lithium ion half-cell based on the common lithium sheet is only 85.3 mAh·g⁻¹. Results show that the protective layer of the lithium metal negative electrode can not only improve a charge and discharge capacity of the battery, but also improve a cycle stability and a cycle life of the battery.

FIG. 6 is a diagram of rate performance comparison between the lithium ion half-cell with the protective layer of the lithium negative electrode (the lithium sheet with a Nafion@MoS₂ protective interlayer) and the lithium ion half-cell based on the common lithium sheet. It can be seen from FIG. 6 that after the lithium-ion half-cell with the protective layer of the lithium negative electrode is cycled at rates of 0.1 C, 0.2 C, 0.5 C, 1 C, 2 C and 0.1 C in sequence, the discharge capacities are 330.3 mAh·g⁻¹, 264.5 mAh·g⁻¹, 196.4 mAh·g⁻¹, 72.1 mAh·g⁻¹, 37.2 mAh·g⁻¹ and 278.1 mAh·g⁻¹ respectively, which are much higher than those of the lithium-ion half-cell based on the common lithium sheet (corresponding to 90 mAh·g⁻¹, 74.2 mAh·g⁻¹, 57.2 mAh·g⁻¹, 46.3 mAh·g⁻¹, 31.7 mAh·g⁻¹ and 92.3 mAh·g⁻¹ respectively).

It can be known from the above experiments that the lithium-ion half-cell with the protective layer of the lithium negative electrode has better advantages and effectiveness than the lithium-ion half-cell based on the common lithium sheet.

The above examples are the preferred examples of the present disclosure, but the examples of the present disclosure are not limited by the above examples. Any other changes, modifications, substitutions, combinations, and simplifications made without departing from the spirit and principle of the present disclosure should be equivalent substitute modes, and should be included in the scope of protection of the present disclosure.

1. A lithium negative electrode with a protective layer, wherein the protective layer of the lithium negative electrode is located on a surface of an electrode, and the protective layer is a lithiated perfluorosulfonic acid membrane doped with nano molybdenum disulfide.

2. The lithium negative electrode with the protective layer according to claim 1, wherein in the protective layer, a mass ratio of the nano molybdenum disulfide to the lithiated perfluorosulfonic acid is 1: (0.5˜2).

3. The lithium negative electrode with the protective layer according to claim 1, wherein the protective layer has a thickness of 150 μm to 350 μm.

4. A preparation method for the lithium negative electrode with the protective layer according to claim 1, comprising the following steps of:
I. lithiation of the perfluorosulfonic acid
1) mixing a lithium source compound with a perfluorosulfonic acid resin solution to obtain a lithiated perfluorosulfonic acid dispersion;
2) drying the lithiated perfluorosulfonic acid dispersion to obtain a solid Li-Nafion polymer; and
3) mixing the solid Li-Nafion polymer with a solvent under stirring to obtain a Li-Nafion dispersion liquid;
II. loading of the molybdenum disulfide
mixing the nano molybdenum disulfide with the Li-Nafion dispersion liquid under stirring to obtain a loading liquid; and
III. coating and curing of the protective layer
coating the loading liquid on a surface of a lithium sheet, and drying to obtain the lithium negative electrode with the protective layer.

5. The preparation method according to claim 4, wherein in the step 1) of the lithiation of the perfluorosulfonic acid, a dosage ratio of Li in the lithium source compound to the perfluorosulfonic acid resin solution is 1 g: (1˜5) L.

6. The preparation method according to claim 5, wherein in the step 1) of the lithiation of the perfluorosulfonic acid, the lithium source compound is selected from at least one of lithium acetate, lithium carbonate, lithium fluoride, lithium hydroxide, lithium oxalate, and lithium chloride; and a mass percentage of the perfluorosulfonic acid resin in the perfluorosulfonic acid resin solution is 1% to 10%.

7. The preparation method according to claim 4, wherein in the step 3) of the lithiation of the perfluorosulfonic acid, a mass ratio of the solid Li-Nafion polymer to the solvent is 1: (50˜200).

8. The preparation method according to claim 4, wherein in the step of the loading of the molybdenum disulfide, a mass ratio of the nano molybdenum disulfide to the Li-Nafion dispersion liquid is 1: (20˜200).

9. (canceled)

10. A lithium-sulfur battery, wherein a negative electrode of the lithium-sulfur battery is the lithium negative electrode according to claim 1.
